(19) United States
(12) Patent Application Publication
(10) Pub. No.: US 2007/0206483 A1
(43) Pub. Date: Sep. 6, 2007

(54) METHOD OF SHIFTING ROTATIONAL SPEED OF DISC AND DISC DRIVE USING THE SAME

(75) Inventor: Yu-Cheng Ko, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,455

(22) Filed: Aug. 10, 2006

(30) Foreign Application Priority Data
Mar. 2, 2006 (CN) 200610034115.8

(51) Int. Cl. G11B 17/04

(52) U.S. Cl. 369/189

(57) ABSTRACT

A method is provided for shifting a rotational speed of a disc. The method includes steps of: detecting a state of a button to determine whether the button is pressed down; counting activating duration if the button is pressed down; determining whether the activating duration is up to a predetermined time; and switching the rotational speed of the disc from a first speed level to a second speed level, if the activating duration is up to a predetermined time. A related disc drive using the method to shift the rotational speed of the disc is also provided.

### FIELD OF THE INVENTION

This invention relates to disc drives and, more particularly, to a disc drive using a method of shifting rotational speed of a disc.

### DESCRIPTION OF RELATED ART

Data discs have become increasingly popular as information storage media due to their vast storage capacity and relatively compact structures. Related disc drives are used to record information on and/or reproduce information from the data discs. Following improvements in storage capacity of the data discs, rotational speeds of the disc drives are also increased.

A general disc drive includes a spindle motor for driving a disc to rotate. Therefore, a rotational speed of the spindle motor determines a rotational speed of the disc. The disc drive can automatically adjust the rotational speed of the spindle motor during focusing and tracking operations. For example, when reproducing information from the disc, the disc drive drives the spindle motor to rotate at a relatively high speed after startup. Rotation of the spindle motor at the relatively high speed may cause vibration of the disc drive due to reasons such as physical defaults of the disc, thus making it hard for the disc drive to perform focusing and tracking operations. In order to accurately reproduce the information recorded on the disc, the disc drive keeps adjusting the rotational speed of the spindle motor to a relative lower speed until the disc drive can track and focus a target track on a predetermined spot. Therefore, it will cost a relative long time to accurately reproduce the information on the disc. Furthermore, in some instances, the rotation of the spindle motor at relatively high speed may cause unwanted faults.

Therefore, a method of shifting rotational speed of the disc and a disc drive using the method is desired.

### SUMMARY OF THE INVENTION

A method is provided for shifting a rotational speed of a disc. The method includes steps of: detecting a state of a button to determine whether the button is pressed down; counting activating duration if the button is pressed down; determining whether the activating duration is up to a predetermined time; and switching the rotational speed of the disc from a first speed level to a second speed level, if the activating duration is up to a predetermined time.

A disc drive includes a spindle motor, a servo controller, a button, and a shifting device. The spindle motor is used for driving a disc to rotate. The servo controller is used for controlling a rotational speed of the disc. The shifting device sends shifting commands to the servo controller to shift the rotational speed of the disc from a first level to a second level, if a activating duration during which the button is kept being pressed down is up to a predetermined time.

A storage medium is provided for recording a computer-executable program. The computer-executable program has a computer execute steps of: detecting a state of a button to determine whether the button is pressed down; counting activating duration if the button is pressed down; determining whether the activating duration is up to a predetermined time; and shifting the rotational speed of the disc from a first speed level to a second speed level, if the activating duration is up to a predetermined time.

Other advantages and novel features will become more apparent from the following detailed description of preferred embodiments when taken in conjunction with the accompanying drawings, in which:

### BRIEF DESCRIPTION OF THE DRAWINGS

Many aspects of the method of shifting a rotational speed of a disc and the disc drive with the method can be better understood with reference to the following drawings. The components in the drawings are not necessarily to scale, the emphasis instead being placed upon clearly illustrating the principles of the present disc drive. Moreover, in the drawings, like reference numerals designate corresponding parts throughout the several views.

FIG. 1 is an exploded, isometric view of a disc drive;

FIG. 2 is a block diagram of the disc drive of FIG. 1, the disc drive including a shifting device;

FIG. 3 is a block diagram of the shifting device of FIG. 1; and

FIG. 4 is a flow chart illustrating a rotational speed shifting procedure in accordance with an exemplary embodiment.

### DETAILED DESCRIPTION OF THE INVENTION

Reference will now be made to the drawings to describe the preferred embodiment of the present method of shifting a rotational speed of a disc and the present disc drive with the present method, in detail.

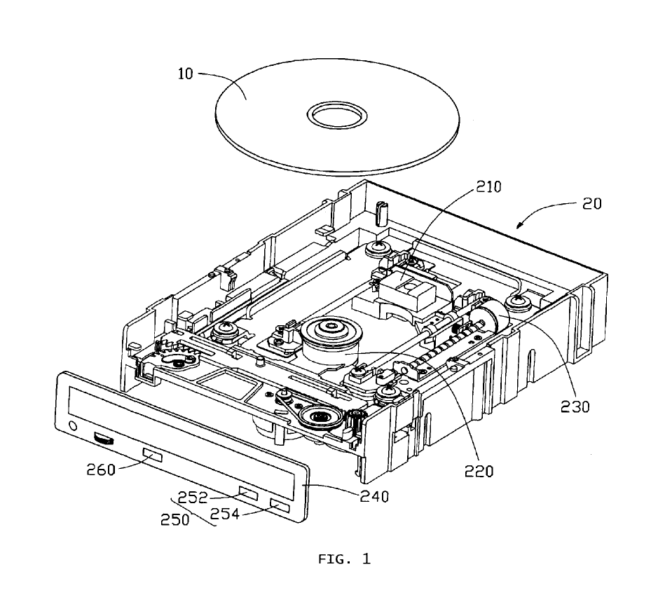

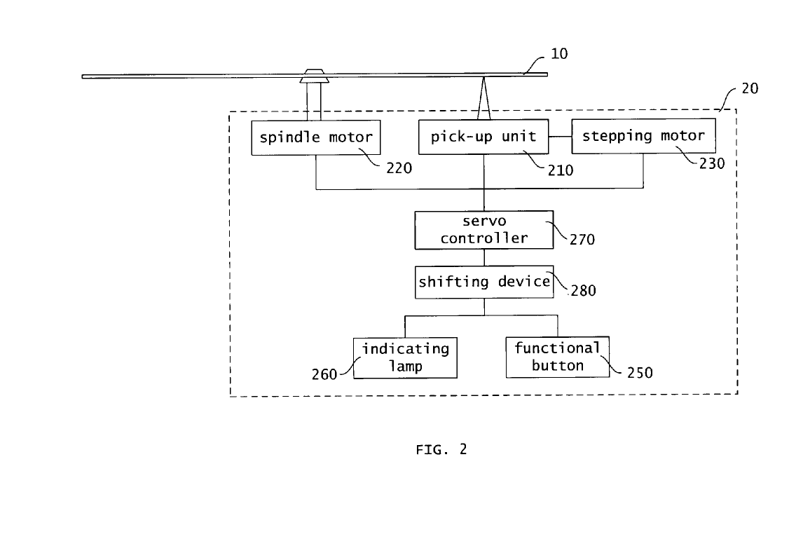

Referring to FIG. 1 and FIG. 2, a disc drive 20 that is used for reproducing information recorded on a disc 10, includes a pick-up unit 210, a spindle motor 220, a stepping motor 230, a control panel 240, a plurality of functional buttons 250, an indicating lamp 260, a servo controller 270, and a shifting device 280.

The pick-up unit 210 is used for emitting a laser beam onto the disc 10 so as to reproduce information recorded on the disc 10 or record information onto the disc 10. The spindle motor 220 is used for driving the disc 10 to rotate. The stepping motor 230 is used for driving the pick-up unit 210 to move along a radial direction of the disc 10.

Usually, the functional buttons 250 include a play button 252 for activating reproducing operations of the disc drive 20, and an open/close button 254 for activating a movement of a disc tray (not shown) out from or into the disc drive 20. Any one of the functional buttons 250 may be assigned for activating a shifting of a rotational speed of the disc 10 from a first speed level to a second speed level. The assigned functional button 250 that is used for activating shifting of a rotational speed of the disc 10 is identified as a shifting button. If the play button 252 or the open/close button 254 is chosen as the shifting button, it inherits an original function of activating reproducing operations of the disc drive 20 or activating movement of the disc tray, and further exists an additional function of activating the shifting of the rotational speed of the disc 10. In order to identify the activation of the original function from an activation of the additional function, the additional function is not activated until the shifting button is applied a force (held down) thereon for a continuous predetermined time. Since the open/close button 254 is prone to cause unexpected movement of the disc tray due to manual operational mistakes, it is better to choose the play button 252 as the shifting button.

Usually, the indicating lamp 260 is used for indicating working states of the disc drive 20. In this embodiment, the indicating lamp 260 is also used for indicating by twinkling that a duration of the force applied on the shifting button has lasted for the continuous predetermined time.

The servo controller 270 is used for controlling rotational speeds of the spindle motor 220 and the stepping motor 230 to perform focusing operations and tracking operations.

The shifting device 280 is used for determining whether an activating duration during which the force applied on the shifting button reaches the continuous predetermined time. If the activating duration is less than the continuous predetermined time, the original function of the shifting button is performed. The shifting device 280 further controls the indicating lamp 26 to twinkle and sends speed shifting commands to the servo controller 270 so that the servo controller 270 changes the rotational speed of the spindle motor 220 from the first speed level to the second speed level if the activating duration reaches the continuous predetermined time. Accordingly, the rotational speed of the disc 10 is changed corresponding a change of the rotational speed of the spindle motor 220.

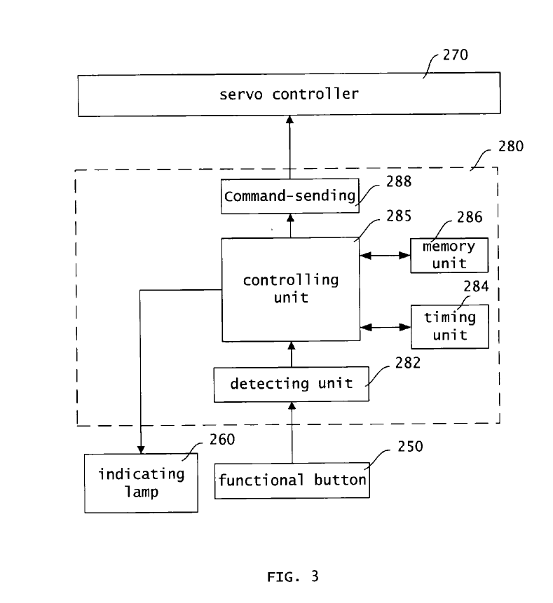

Referring to FIG. 3, the shifting device 280 includes a detecting unit 282, a timing unit 284, a controlling unit 285, a memory unit 286, and a command-sending unit 288.

The detecting unit 282 is used for detecting a state of the shifting button at regular time intervals to determine whether the shifting button is pressed down or released. Such regular time intervals, for example, can be every millisecond.

The timing unit 284 is used for timing the activating duration during which the shifting button is pressed down.

The controlling unit 285 is used for controlling working states of the timing unit 284 and the indicating lamp 260 according to the state of the shifting button and the activating duration. When the detecting unit 282 detects that the shifting button is pressed down, the controlling unit 285 controls the timing unit 284 to begin timing the activating duration. When the detecting unit 282 detects that the shifting button is released or that the activating duration reaches the continuous predetermined time, the controlling unit 285 controls the timing unit 284 to stop timing the activating duration. When the activating duration reaches the continuous predetermined time, the controlling unit 285 controls the indicating lamp 260 to twinkle.

The memory unit 286 is used for storing the continuous predetermined time and the speed levels of the disc 10. Exemplarily, the continuous predetermined time is three seconds. For any data discs, respective specifications specify a data transfer rate corresponding to a base rotational speed. For example, specifications of compact disc audio (CD_DA) specify that the data transfer rate corresponding to a base rotational speed (so called 1×) is 150 Kbps. Doubling the base rotational speed (so called 2×) would double the data transfer rate. In this embodiment, such speed level may be 1×, 2×, 4×, 6×, 8×, 16×, 32×, or 40×. The number of the speed levels can be ten. That is, the rotational speed of the disc can be shifted among the ten speed levels.

The command-sending unit 288 is used for sending shifting commands to the servo controller 270 so as to shift the rotational speed of the spindle motor 220 and the disc 10.

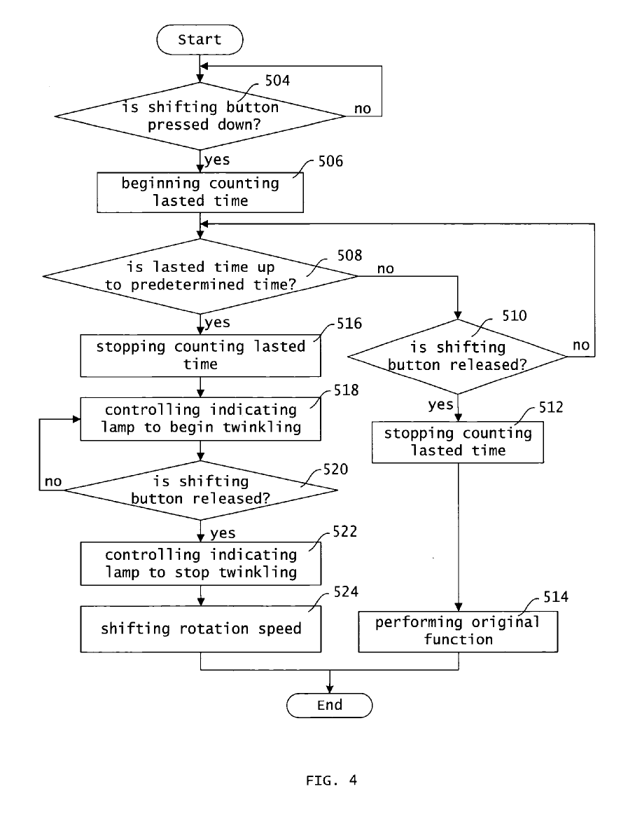

Referring to FIG. 4, a flow chart of a rotational speed shifting procedure is illustrated. First, in step 504, the detecting unit 282 detects the state of the shifting button to determine whether the shifting button is pressed down.

If the detecting unit 282 detects that the shifting button is pressed down, in step 506, the detecting unit 282 informs the controlling unit 285 of the state of the shifting button, and the controlling unit 285 controls the timing unit 284 to begin timing the activating duration.

Subsequently, in step 508, the controlling unit 285 determines whether the activating duration reaches the continuous predetermined time.

If in step 508 the activating duration is concluded to be less than the continuous predetermined time, the detecting unit 282 detects the state of the shifting button to determine whether the shifting button is released (step 510).

If in step 510 the shifting button is concluded to be not released, the procedure goes back to step 508. If in step 510 the shifting button is concluded to be released, the procedure proceeds to step 512 where the controlling unit 285 controls the timing unit 284 to stop timing the activating duration. Then, in step 514, the disc drive 20 performs the original function of the shifting button.

If in step 508, the activating duration is concluded to reach the predetermined time, the controlling unit 285 controls the timing unit 284 to stop timing the activating duration (step 516), and controls the indicating lamp 260 to begin twinkling (step 518).

Then, in step 520, the detecting unit 282 detects the state of the shifting button to determine whether the functional button is released.

If the functional button is released, in step 522, the controlling unit 285 controls the indicating lamp 260 to stop twinkling.

Subsequently, in step 524, the command-sending unit 288 sends shifting commands to the servo controller 270 to shift the rotational speed of the disc from the first speed level to the second speed level. After that, the procedure is ended.

The disc drive 20 allows a user to shift the rotational speed of the disc 10 to a relative low speed during an initialization process of the disc drive 20. During focusing and tracking process, if it is hard to seek a specific target track and/or focus on a specific spot, rotation of the disc 10 at the relative low speed may help the disc drive to perform focusing and tracking operations in a relatively short time.

The embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims that follow, and their equivalents.

What is claimed is:

1. A method of shifting a rotational speed of a disc, comprising steps of:
detecting a state of a button to determine whether the button is pressed down;
counting activating duration if the button is pressed down;
determining whether the activating duration is up to a predetermined time; and
switching the rotational speed of the disc from a first speed level to a second speed level, if the activating duration is up to a predetermined time.

2. The method as claimed in claim 1, wherein the step of switching comprises steps of:
detecting the state of the button to determine whether the button is released; and
changing the rotational speed of the disc from the first speed level to the second speed level if the activating duration is up to a predetermined time and the button is released.

3. The method as claimed in claim 1, further comprising a step of controlling an indicating lamp to twinkle if the activating duration is up to a predetermined time.

4. The method as claimed in claim 3, further comprising a step of controlling the indicating lamp to stop twinkling if the button is released.

5. The method as claimed in claim 1, further comprising a step of stopping counting the activating duration if the button is released or the activating duration is up to the predetermined time.

6. The method as claimed in claim 1, wherein the button is a play button of a disc drive for activating the disc drive to reproduce the disc.

7. A disc drive comprising:
a spindle motor for driving a disc to rotate;
a servo controller for controlling a rotational speed of the spindle motor;
a button for activating shifting of the rotational speed; and
a shifting device for sending shifting commands to the servo controller to shift the rotational speed from a first level to a second level, if an activating duration during which the button keeps being pressed down is up to a predetermined time.

8. The disc drive as claimed in claim 7, wherein the shifting device comprises a detecting unit for detecting whether the button is pressed down.

9. The disc drive as claimed in claim 8, wherein the shifting device comprises a timing unit for counting the activating duration when the button is pressed down.

10. The disc drive as claimed in claim 9, wherein the shifting device comprises a command-sending unit for sending the shifting commands to the servo controller.

11. The disc drive as claimed in claim 10, wherein the shifting device comprises a controlling unit for controlling the timing unit to begin counting the activating duration if the button is pressed down, controlling the timing unit to stop counting the activating duration if the button is released or the activating duration is up to the predetermined time, and controlling the command sending unit to sending the shifting commands to the servo controller if the activating duration is up to the predetermined time.

12. The disc drive as claimed in claim 10, further comprising an indicating lamp for twinkling if the activating duration is up to the predetermined time.

13. The disc drive as claimed in claim 12, wherein the button is a play button of the disc drive.

14. A storage medium for recording a computer-executable program, the computer-executable program having a computer executable steps of:
detecting a state of a button to determine whether the button is pressed down;
counting activating duration if the button is pressed down;
determining whether the activating duration is up to a predetermined time; and
shifting the rotational speed of the disc from a first speed level to a second speed level, if the activating duration is up to a predetermined time.

15. The storage medium as claimed in claim 14, wherein the step of shifting comprises steps of:
detecting the state of the button to determine whether the button is released,
shifting the rotational speed of the disc from the first speed level to the second speed level, if the activating duration is up to a predetermined time and the button is released.

16. The storage medium as claimed in claim 14, wherein the computer-executable program has the computer executable a step of controlling an indicating lamp to twinkle if the activating duration is up to a predetermined time.

17. The storage medium as claimed in claim 16, wherein the computer-executable program has the computer executable a step of controlling the indicating lamp to stop twinkling if the button is released.

18. The storage medium as claimed in claim 14, wherein the computer-executable program has the computer executable a step of stopping counting the activating duration if the button is released or the activating duration is up to the predetermined time.
